(19) United States
(12) Patent Application Publication
(10) Pub. No.: US 2017/0332127 A1
(43) Pub. Date: Nov. 16, 2017

(54) METHOD AND APPARATUS FOR VIDEO PICTURE PLAYBACK

(71) Applicant: THOMSON LICENSING, Issy les Moulineaux (FR)

(72) Inventors: Zhengdong WEI, BEIJING (CN); Yuanhuai YANG, Beijing (CN); Qinglei YANG, Qing Zhou City (CN); Dongsheng Qu, BEIJING (CN); Qianlong YU, BEIJING (CN)

(21) Appl. No.: 15/533,001

(22) PCT Filed: Dec. 4, 2014
(86) PCT No.: PCT/CN2014/093059

§ 371 Date: Jun. 2, 2017

(51) Int. Cl. H04N 21/4147; H04N 19/59; H04N 19/426; H04N 19/44; H04N 21/845; H04N 19/593

(52) U.S. Cl. CPC H04N 21/4147; H04N 21/8455; H04N 19/593; H04N 19/428; H04N 19/44; H04N 19/59

(57) ABSTRACT

The present disclosure provides a video picture playback method, comprising : monitoring a video stream to detect whether an I-Frame picture arrives; and storing the I-Frame picture or compressed I-Frame picture into a memory when the I-Frame picture arrives.

### TECHNICAL FIELD

The present disclosure relates to a digital audio/video system, and more particularly to a video picture playback apparatus and method.

### BACKGROUND

In current electrical device market, there are two kinds of Set Top Box, the one is Zapper box which has not PVR (Personal video recorder) function, another one is PVR box which could records TV program or movie in HDD (such as, embedded HDD or USB HDD).

For the zapper box, user could not record anything. That means user couldn't see any program that is past even if one second past. In this case, if user wants to note or record some important information in TV program, he/she has to do full preparation and very quick action, because the picture with the information he/she wants will disappear soon.

### SUMMARY

Additional aspects and advantages of the present disclosure will be set forth in the description which follows, and in part will be apparent from the description, or may be learned by practice of the disclosure.

The present disclosure provides a video picture playback method, comprising: monitoring a video stream to detect whether an I-Frame picture arrives; and storing the I-Frame picture or compressed I-Frame picture into a memory when the I-Frame picture arrives.

The present disclosure further provides a video picture playback apparatus, comprising: a monitor unit configured to monitor a video stream to detect whether I-Frame picture arrives; and a storing unit configured to store I-Frame or compressed I-Frame picture into a memory when I-Frame picture arrives.

### BRIEF DESCRIPTION OF THE DRAWINGS

The preferred embodiments of the present disclosure will be detailed in conjunction with drawings. The above and other objects, characteristics and advantages of the present disclosure will become more apparent. In the drawings, same numbers designate units having same structures, and wherein:

FIG. 1 shows a block diagram of the structure of the zapper box in the prior art;

FIG. 2 shows a flowchart of a video picture playback storing method of the zapper box according to the embodiment of the present disclosure;

FIG. 3 shows a flowchart of a video picture playback playing method of the zapper box according to the embodiment of the present disclosure;

FIG. 4 shows a block diagram of a video picture playback storing apparatus of the zapper box according to the embodiment of the present disclosure;

FIG. 5 shows a block diagram of a video picture playback playing apparatus of the zapper box according to the embodiment of the present disclosure.

### DETAILED DESCRIPTION

The present disclosure will be described fully below with reference to drawings showing embodiments of the present disclosure. However, the present disclosure can be implemented in many different forms, and should not be considered as limiting to the embodiments described herein. Instead, these embodiments are provided to make the present disclosure thorough and complete, and express fully the scope of the present disclosure to those skilled in the art. In the drawings, the components are exaggerated for clarity.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Like reference symbols refer to like elements. As used herein, the term “and/or” includes any and all combinations of one or more of the associated listed items.

It will be understood that, although the terms first, second, third etc. may be used herein to describe various elements, components, and/or sections, these elements, components, and/or sections should not be limited by these terms. These terms are only used to distinguish one element, component, or section from each other. Thus, a first element, component, or section discussed below could be termed a second element, component, or section without departing from the teachings of the present disclosure.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise. It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meanings as what those ordinary skilled in the art the present disclosure belongs to commonly understand. It should be further appreciated that the terms such as those defined in usual dictionaries should be construed as having meanings consistent with their meanings in the context of related art, and should not be construed in an ideal or extremely formalized sense, unless so defined expressly herein.

The present disclosure aims at the zapper box that does not have HDD (hard disk driver) for recording function or any other video playback device that does not have HDD. In the present disclosure, the following situations need to be solved:
i. A user wants to record a phone number that is displayed in TV screen. But when he is looking for a pen and paper, the picture in the TV screen changes and the picture with the phone number has gone.
ii. A very good restaurant is suggested in a TV program, the name and address are strange and long for the viewer, he wants to record them but this information is only displayed two seconds. The user hasn't had enough time to record all useful information.

A method and apparatus are provided so that user could back to watch several-second video picture in past. Thus the user could have enough time to note some information.

There are two procedures (storing and playing) according to the embodiment of the present disclosure.

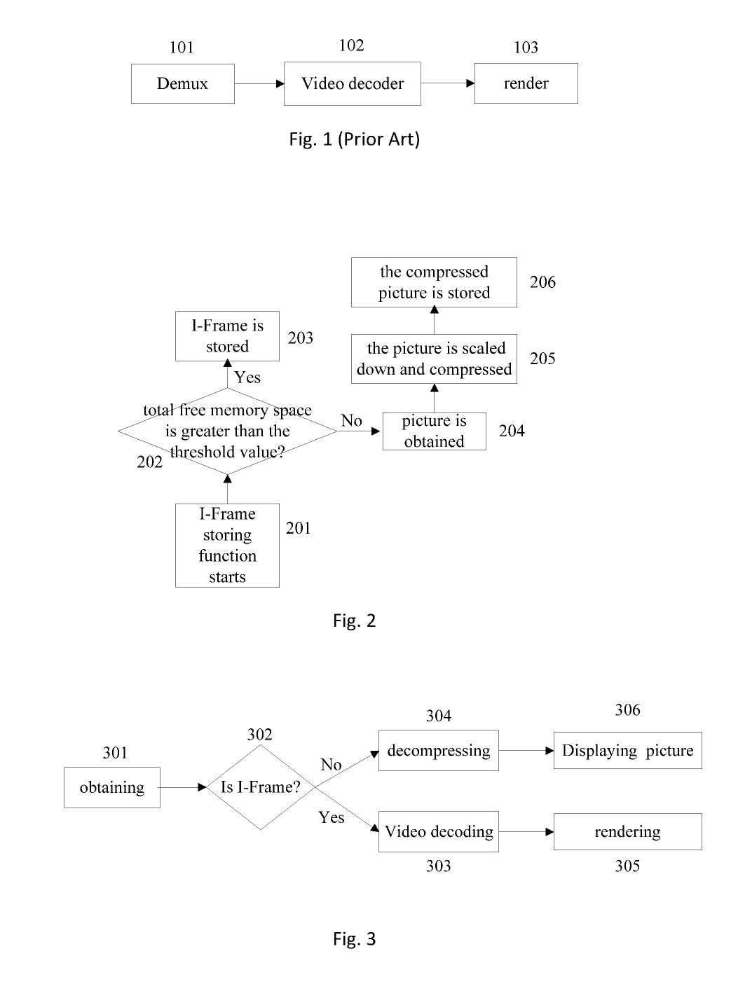

FIG. 1 shows a block diagram of the structure of the zapper box in the prior art.

As shown in FIG. 1, the zapper box comprises a demux 101, a video decoder 102, and a render 103. The demux 101 demultiplexes the TS (transport stream) into video stream, audio stream and data stream. The video decoder 102 decodes video stream, audio stream and data stream into video signal, audio signal and data signal. The render 103 renders the video signal, audio signal and data signal.

The main idea of the disclosure is to store I-Frame or small picture within several past seconds in memory, such as, RAM or flash without using external storage, such as hard disk or hard driver.

FIG. 2 shows a flowchart of a video picture playback storing method of the zapper box according to the embodiment of the present disclosure.

The important step is to manage free memory space (or called available memory space). During storing process, all this free memory space size should be managed. The present disclosure uses free memory space, which is not used by programs and program data, to store I-Frame pictures. In this procedure, it is expected that STB could save several I-Frame (such as, 10-30 I-Frames) or picture in nearest past several seconds (such as, 2-5 seconds). FIG. 2 shows the whole storing procedure.

At step 201, the function for monitoring and storing I-Frame pictures starts according to the instruction of the user. And it begins to monitor the video stream to detect whether I-Frame picture arrives.

At step 202, it determines if free memory space at the time of starting function for storing I-Frame pictures is greater than a threshold value. If the size of free memory space is greater than the threshold value, then go to step 203; otherwise, go to step 204.

The threshold value is set according to practical needs and practical situation, such as, the user setting playback duration, the total free memory space and so on. Such as, the threshold value can be set to 10 MByte. According to a second example, the threshold value is calculated based on the expected recording duration by using the following steps: when the function of storing I-Frame picture starts, it calculates a value A with a formula: recording duration*estimated I-Frame size. If the free memory space at the time of calculation is greater than the value A, the value A is used as the threshold value and it is the I-Frame picture that is going to be stored. Or otherwise, it calculates a value B with a formula: recording duration*estimated compressed I-Frame size. If the free memory space at the time of calculation is greater than the value B, the value B is used as the threshold value and it is the compressed I-Frame picture that is going to be stored. If the free memory space is less than the value B, the function can't be started.

At step 203, the I-Frame picture is stored into the memory unit.

At step 204, the video stream is decoded to obtain the I-Frame picture, and then go to step 205.

At step 205, the size of the I-Frame picture is scaled down to a predetermined size and then is compressed into compressed picture, then go to step 206.

The predetermined size can be set according to the practical situation. Such as, the predetermined size is set to 352×288.

For example, the HD picture size (1080×720×3) is about 2.3 Mbyte, because I-frame was compressed, so the size is about 0.8 Mbyte. There are about 5-7 I-frame each second, so the required storage space is 5.6 Mbyte (0.8×7) per second. If the user wants to save I-frame 5 seconds, 28 Mbyte storage space is needed. Thus, if the picture is scaled down to such as 352×288 and compressed 50%, then 5 s I-frame only needs less than 6 Mbyte storage space.

At step 206, the compressed picture is stored into the memory unit.

During the storage at the steps 203 and 206, it keeps total size of stored I-Frame pictures or compressed I-Frame pictures is not more than the threshold value, and if the storage of a new I-Frame picture or compressed I-Frame picture makes the total size greater than the threshold value, it managers the stored I-Frame pictures or compressed I-Frame pictures in a first-in-first-out manner. In other words, before a new I-Frame picture or compressed I-Frame picture is stored, it determines if (used memory for storing I-Frame pictures or compressed I-Frame pictures+new I-Frame picture or compressed I-Frame picture) is larger than the threshold value. If yes, it removes the first-most I-Frame picture or compressed I-Frame picture in a first-in-first-out manner. If no, it stores the I-Frame picture or compressed I-Frame picture.

FIG. 3 shows a flowchart of a video picture playback playing method of the zapper box according to the embodiment of the present disclosure.

When the user wants to record some valuable info that is displayed /scrolled in screen, he/she could stop current live play and go back to see each stored picture. FIG. 3 shows us the process in STB.

At step 301, the content stored in the memory unit is obtained according to the instruction of the user.

At step 302, determining whether the content in the memory unit is I-Frame or compressed picture. If it is determined that the content in the memory unit is I-Frame, go to step 303; otherwise go to step 304.

At step 303, video decoding is performed on the I-Frame into video signal, and then at step 305, the video signal is rendered and displayed.

At step 304, the compressed picture is decompressed, and then at step 306, picture is displayed on the screen.

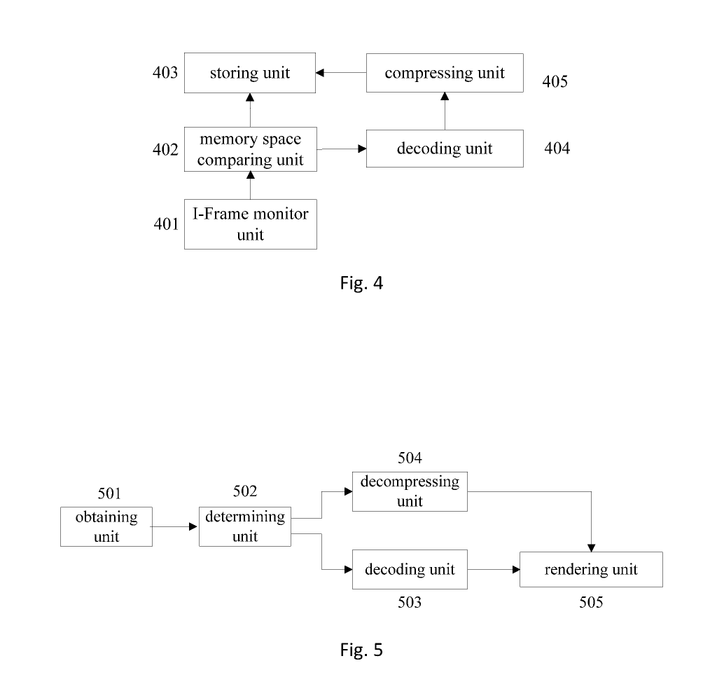

FIG. 4 shows a block diagram of a video picture playback storing apparatus of the zapper box according to the embodiment of the present disclosure.

The video picture playback storing apparatus comprises an I-Frame monitor unit 401, a memory space comparing unit 402, a storing unit 403, a decoding unit 404, and a compressing unit 405.

The I-Frame monitor unit 401 monitors the video stream to detect whether I-Frame picture arrives.

At the time of starting function for storing I-Frame pictures, memory space comparing unit 402 determines if free memory space at the time of starting function for storing I-Frame pictures is greater than a threshold value. If the size of free memory space is greater than the threshold value, then the storing unit 403 stores the I-Frame picture into memory.

If the size of free memory space is smaller than the threshold value, then decoding unit 404 decodes the video stream to obtain the I-Frame picture.

The compressing unit 405 scales down the size of the I-Frame picture to a predetermined size (such as, 352×288), and compresses it into compressed picture so that the storing unit 403 stores the compressed picture into available memory unit.

FIG. 5 shows a block diagram of a video picture playback playing apparatus of the zapper box according to the embodiment of the present disclosure.

The video picture playback playing apparatus comprises an obtaining unit 501, a determining unit 502, a decoding unit 503, a decompressing unit 504 and a rendering unit 505.

The obtaining unit 501 obtains the content stored in the memory unit according to the instruction of the user.

The determining unit 502 determines whether the content in the memory unit is I-Frame or compressed picture. If it is determined that the content in the memory unit is I-Frame, the decoding unit 503 decodes the I-Frame into a video signal, and the rendering unit 505 renders and displays the video signal.

If it is determined that the content in the memory unit is compressed picture, the decompressing unit 504 decompresses the compressed picture into video signal, and the rendering unit 505 renders and displays the video signal.

The above is the description for the present disclosure, and should not be considered as a limitation thereto. Although several exemplary embodiments of the present disclosure are described, those skilled in the art will readily understand, without departing from the novel teaching and advantages of the present disclosure, many modifications can be made to the exemplary embodiments,. Accordingly, all such modifications are intended to be included within the scope of the present disclosure defined by the claims. It should be understood that the above is the description for the present disclosure, and should not be considered limited to the disclosed particular embodiments, and modifications to the disclosed embodiments and other embodiments are intended to be included within the scope of the appended claims. The present disclosure is defined by the appended claims and their equivalents.

1. A method for displaying a picture in a video, comprising:
monitoring a video stream of the video to detect whether an I-Frame picture arrives;
storing the I-Frame picture or compressed I-Frame picture into a memory; and
upon a display instruction, displaying the I-Frame picture or the compressed I-Frame picture stored in the memory.

2. The method according to claim 1, wherein the step of storing further comprises:
determining if free memory space in the memory at the time of starting a function for storing I-Frame pictures is greater than a threshold value;
if positive, storing the I-Frame picture into the memory; and
if negative, storing the compressed I-Frame picture into the memory.

3. The method according to claim 2, wherein the step of storing the compressed I-Frame picture into the memory further comprises:
decoding the video stream to obtain the I-Frame picture;
scaling down the size of the I-Frame picture to a predetermined size picture and compressing the predetermined size picture into the compressed picture;
storing the compressed I-Frame picture into the memory.

4. The method according to claim 3, further comprising:
obtaining content stored in the memory;
displaying at least one I-Frame picture or compressed I-Frame picture.

5. The method according to claim 4, the step of obtaining further comprises:
determining whether the content in the memory is a type of I-Frame picture or compressed I-Frame picture;
decoding the at least one I-Frame picture into video signal if it is determined that the content in the memory is a type of I-Frame picture, and displaying the video signal;
decompressing the compressed picture into video signal if it is determined that the content in the memory is a type of compressed I-Frame picture, and displaying the video signal.

6. An apparatus for displaying a picture in a video, comprising:
a monitor unit configured to monitor a video stream of the video to detect whether I-Frame picture arrives;
a storing unit configured to store I-Frame or compressed I-Frame picture into a memory; and
a rendering unit configured to upon a display instruction, display the I-Frame picture or the compressed I-Frame picture stored in the storing unit.

7. The apparatus according to claim 6, further comprising:
a memory space comparing unit configured to determine if free memory space in the memory at the time of starting a function for storing I-Frame pictures is greater than a threshold value;
the storing unit further configured to if determination result is positive, storing the I-Frame picture into the memory; and if negative, storing the compressed I-Frame picture into the memory.

8. The apparatus according to claim 7, further comprising:
a decoding unit configured to decode the video stream to obtain the I-Frame picture;
a compressing unit configured to scale down the size of the I-Frame picture to a predetermined size picture and compress the predetermined size picture into the compressed I-Frame picture;
the storing unit further configured to store the compressed I-Frame picture into the memory.

9. The apparatus according to claim 8, further comprising:
an obtaining unit configured to obtain content stored in the memory;
a rendering unit configured to display at least one I-Frame picture or compressed I-Frame picture.

10. The apparatus according to claim 9, further comprising:
a determining unit configured to determine whether the content in the memory is a type of I-Frame picture or compressed I-Frame picture;
the decoding unit further configured to decode the at least one I-Frame picture into video signal if it is determined that the content in the memory is a type of I-Frame picture, and displaying the video signal;
a decompressing unit configured to decompress the compressed picture into video signal if it is determined that the content in the memory is a type of compressed I-Frame picture, and displaying the video signal.
